(19) United States
(12) Patent Application Publication
(10) Pub. No.: US 2017/0246767 A1
(43) Pub. Date: Aug. 31, 2017

(54) PROCESS AND MOLD FOR FABRICATING AN OPTICAL DEVICE, AND AN OPTICAL DEVICE

(71) Applicant: LEDIL OY, Salo (FI)

(72) Inventor: Hannu HUKKANEN, Turku (FI)

(21) Appl. No.: 15/507,506

(22) PCT Filed: Jun. 8, 2015
(86) PCT No.: PCT/FI2015/050393

§ 371 Date: Feb. 28, 2017

(30) Foreign Application Priority Data
Sep. 1, 2014 (FI) 20145753

(51) Int. Cl. B29C 33/00; B29C 45/37; G02B 1/04; B29C 33/64

(52) U.S. Cl. CPC B29C 33/005; B29C 33/64; B29C 45/372; G02B 1/045; B29L 2011/0075

(57) ABSTRACT

A process for fabricating an optical device includes injecting (301) optical silicone into a mold cavity formed by two or more mutually matching mold-elements, curing (302) the optical silicone contained by the mold cavity, and separating (303) the mold-elements from the optical device constituted by the optical silicone. The reversible elasticity of the optical silicone after the curing phase is utilized in the process so that at least one of the mold-elements has counterdraft which causes a reversible deformation in the optical device when the mold-element is separated from the optical device. As the counterdraft is allowable, the shape of the optical device as well as the dividing joints between the mold-elements can be designed more freely. For example, walls of the mold cavity corresponding to optically active surfaces of the optical device can be arranged to be free from dividing joints between the mold-elements.

### FIELD OF THE INVENTION

The invention relates generally to illuminating engineering. More particularly, the invention relates to a process for fabricating an optical device for modifying light distribution. Furthermore, the invention relates to an optical device and to a mold for fabricating an optical device.

### BACKGROUND

Distribution of light produced by a light source can be important or even critical in some applications. The light source can be, for example but not necessarily, a light emitting diode “LED”, a filament lamp, or a gas-discharge lamp. FIG. 1 a shows a section view of an exemplifying optical device 101 according to the prior art for modifying light distribution. Furthermore, FIG. 1a shows section views of mutually matching mold-elements 102, 103, 104, and 105 according to the prior art. The mold-elements 102-105 constitute a mold for fabricating the optical device 101 by mold casting. FIG. 1b shows the section views of the mold-elements 102-105 in a situation where the mold-elements have been separated from each other. The sections shown in FIGS. 1a and 1b are taken along a plane that is parallel with the yz-plane of a coordinate system 199. Channels for conducting the material of the optical device in fluidic state to a mold cavity formed by the mold-elements 102-105 are not presented in FIGS. 1a and 1b. FIG. 1c shows a side view of the optical device 101. The internal shapes of the optical device 101 are depicted with dashed lines in FIG. 1c. The optical device 101 comprises optically active surfaces for modifying light distribution. The optically active surfaces are surfaces which refract and/or reflect light during the operation of the optical device. For example, a surface 106 shown in FIG. 1c is an optically active surface designed to provide total internal reflection “TIR”. For another example, walls of a cavity 109 shown with dashed lines in FIG. 1c are also optically active surfaces.

As can be understood from FIGS. 1a-1c, the optically active surface 106 comprises a mold trace 107 caused by the division joint 108 between the mold-elements 104 and 105. Mold traces of the kind mentioned above are undesirable especially on optically active surfaces of optical devices because the mold traces may direct stray light into directions into which no light should be directed. Furthermore, cavities of an optical device may be challenging because one or more requirements related to the fabrication of the optical device may contradict one or more requirements related to the desired optical properties of the optical device. A cavity of the kind mentioned above is the cavity 109 shown with dashed lines in FIG. 1c. In the exemplifying case illustrated in FIGS. 1a-1c, the shape of the cavity 109 is such that the mold-element 103 can be easily separated from the optical device 101. However, from the viewpoint of the optical properties of the optical device, a more advantageous shape of the cavity 109 might be such that there is a need for counterdraft in a cantilever 110 of the mold-element 103 which forms the cavity 109. A straightforward approach would be to compose the cantilever 109 of many pieces but this would significantly complicate the mold-element 103, and furthermore this approach would create many mold traces on the optically active walls of the cavity 109.

### SUMMARY

The following presents a simplified summary in order to provide a basic understanding of some aspects of various embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new process for fabricating an optical device comprising optically active surfaces for modifying light distribution. The optically active surfaces are surfaces which refract and/or reflect light whose distribution is being modified by the optical device. A process according to the invention comprises:
injecting optical silicone in fluidic state into a mold cavity formed by two or more mutually matching mold-elements,
curing the optical silicone contained by the mold cavity, the optical silicone being reversibly elastic after the curing, and
separating the mold-elements from the optical device constituted by the optical silicone.

The reversible elasticity of the optical silicone after the curing phase is utilized in the process so that at least one of the mold-elements has counterdraft which causes a reversible deformation in the optical device when the mold-element under consideration is separated from the optical device.

As the counterdraft is allowed, the shape of the optical device as well as the dividing joints between the mold-elements can be designed more freely. For example, walls of the mold cavity corresponding to the optically active surfaces of the optical device can be arranged to be free from dividing joints between the mold-elements. Furthermore, in many cases, the number of the mold-elements can be smaller and thus the mold system can be simpler than in a case where the reversible elasticity of the optical silicone is not utilized and, as a corollary, all mold-elements are required to be free from counterdraft.

In a process according to an advantageous, exemplifying and non-limiting embodiment of the invention, the mold-elements form the mold cavity so that walls of the mold cavity corresponding to the optically active surfaces of the optical device are free from the dividing joints between the mold-elements.

In accordance with the invention, there is provided also a new optical device which is obtainable by a process according to the invention.

In an optical device according to an advantageous, exemplifying and non-limiting embodiment of the invention, the optically active surfaces of the optical device are free from traces corresponding to the dividing joints between the mold-elements.

In accordance with the invention, there is provided also a new illuminator system comprising at least one light source and at least one optical device according to the invention for modifying the distribution of the light produced by the at least one light source. Each light source can be, for example, a light emitting diode “LED”, a filament lamp, or a gas-discharge lamp.

In accordance with the invention, there is provided also a new mold for fabricating an optical device comprising optically active surfaces for modifying light distribution. A mold according to the invention comprises two of more mutually matching mold-elements for forming a mold cavity for receiving material of the optical device, wherein at least one of the mold-elements has counterdraft causing a reversible deformation of the optical device when the at least one of the mold-elements is separated from the optical device.

In a mold according to an advantageous, exemplifying and non-limiting embodiment of the invention, the mold-elements are adapted to form the mold cavity so that walls of the mold cavity corresponding to the optically active surfaces of the optical device are free from the dividing joints between the mold-elements.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below with reference to the accompanying drawings, in which:

FIGS. 1a, 1b and 1c illustrate an optical device and a mold according to the prior art,

FIGS. 2a, 2b and 2c illustrate an optical device and a mold according to an exemplifying and non-limiting embodiment of the invention,

FIG. 3 shows a flowchart of a process according to an exemplifying and non-limiting embodiment of the invention for fabricating an optical device, and

FIGS. 4a and 4b illustrate an illuminator system according to an exemplifying and non-limiting embodiment of the invention.

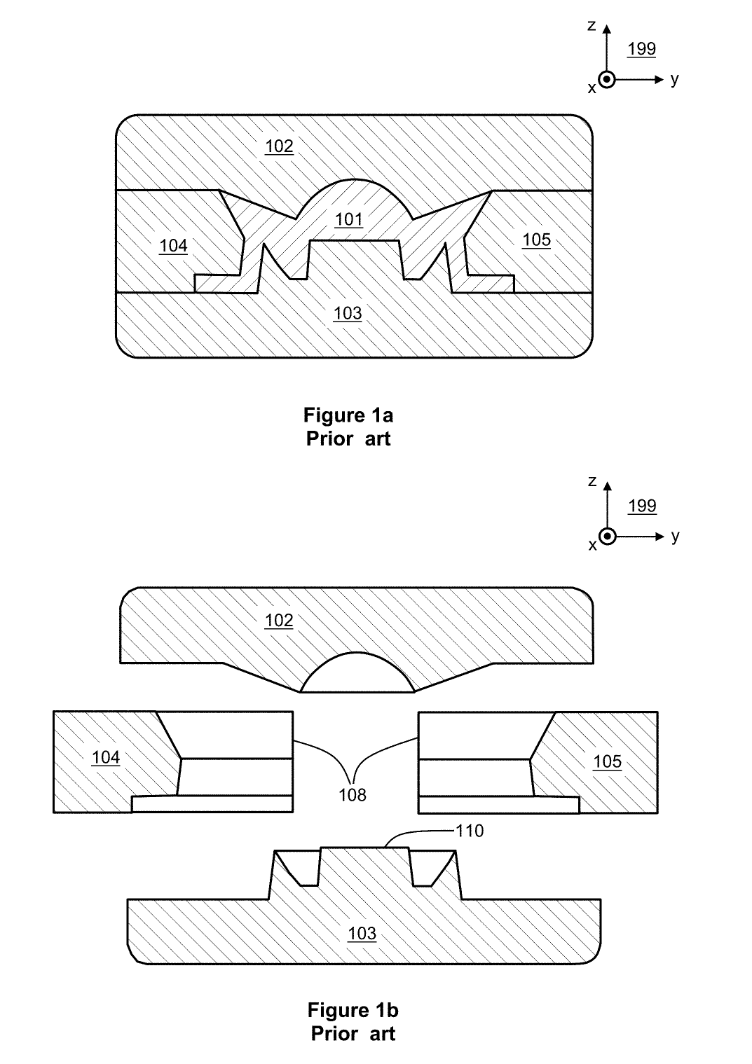

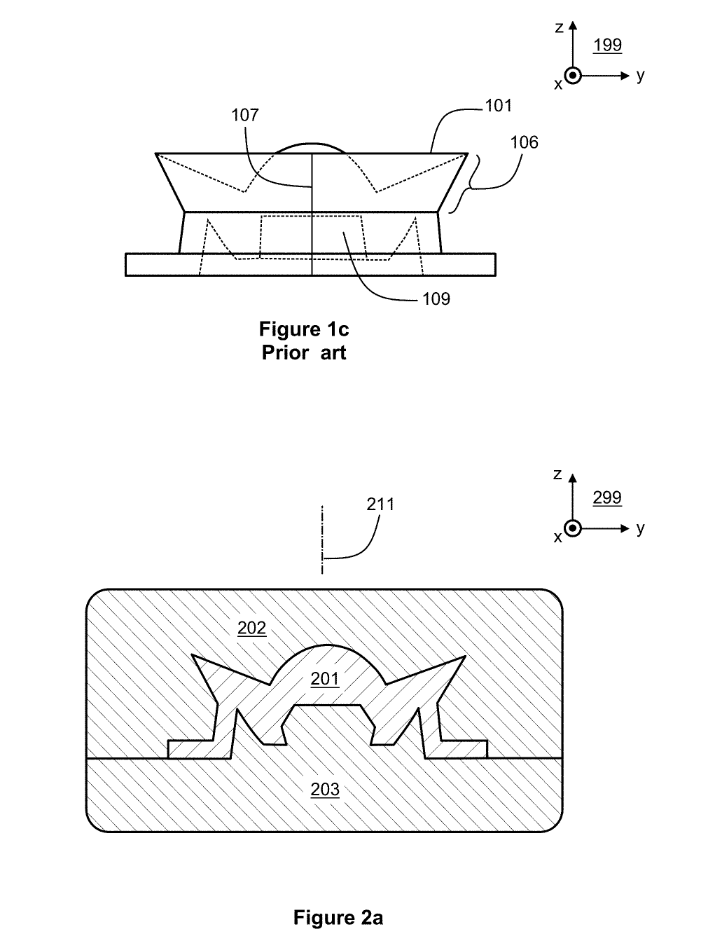

FIGS. 1a, 1b, and 1c have already been explained in the Background-section of this document.

### DESCRIPTION OF EXEMPLIFYING EMBODIMENTS

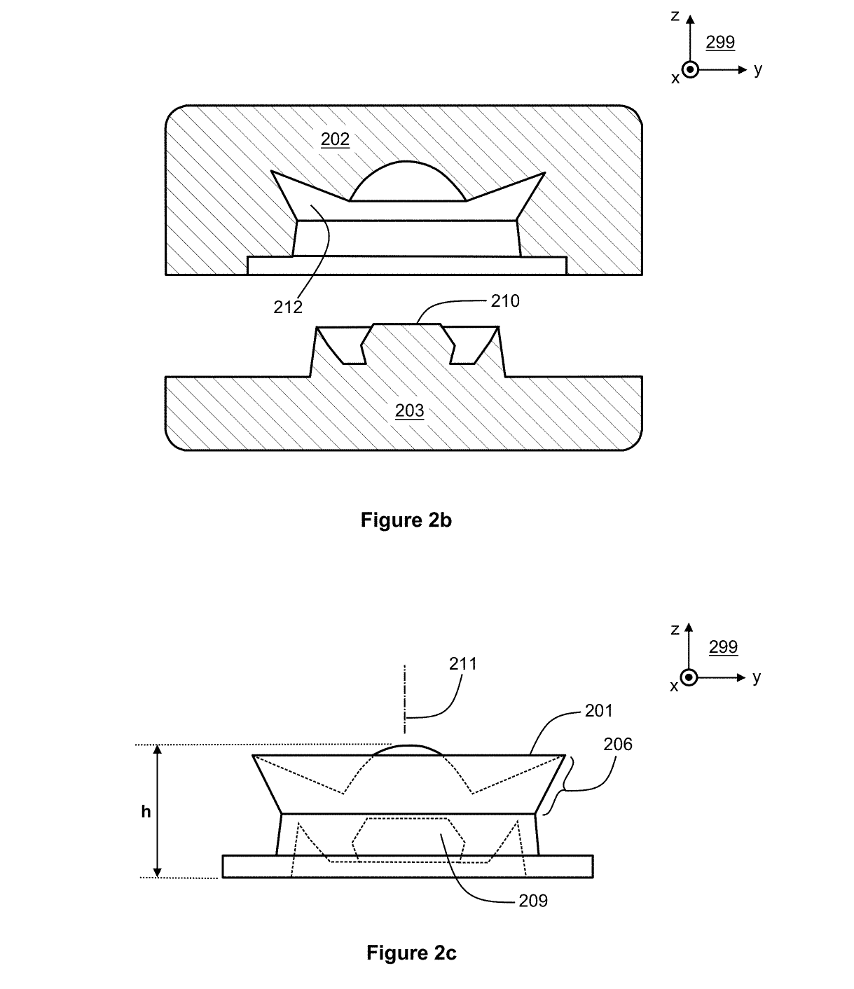

FIG. 2a shows a section view of an exemplifying optical device 201 for modifying light distribution. Furthermore, FIG. 2a shows section views of mutually matching mold-elements 202 and 203 according to an exemplifying and non-limiting embodiment of the invention. The mold-elements 202 and 203 constitute a mold for fabricating the optical device 201 by mold casting. FIG. 2b shows the section views of the mold-elements 202 and 203 in a situation where the mold-elements have been separated from each other. The sections shown in FIGS. 2a and 2b are taken along a plane that is parallel with the yz-plane of a coordinate system 299. Channels for conducting the material of the optical device in fluidic state to a mold cavity formed by the mold-elements 202 and 203 are not presented in FIGS. 2a and 2b. FIG. 2c shows a side view of the optical device 201. The internal shapes of the optical device 201 are depicted with dashed lines in FIG. 2c. The optical device 201 comprises optically active surfaces for modifying light distribution. For example, a surface 206 shown in FIG. 2c is an optically active surface designed to provide total internal reflection “TIR”. For another example, walls of a cavity 209 shown with dashed lines in FIG. 2c are also optically active surfaces.

In the exemplifying case illustrated in FIGS. 2a and 2b, both of the mold-elements 202 and 203 have counterdraft which causes a reversible deformation in the optical device 201 when the mold-elements are separated from the optical device 201. The mold-element 203 comprises a cantilever 210 protruding towards the mold cavity and forming the corresponding cavity 209 on the optical device 201. A part of the cantilever is shaped to have counterdraft causing a reversible deformation in the optical device when the mold-element 203 is separated from the optical device. The exemplifying shape of the cavity 209 shown in FIG. 2c makes it possible to reduce the height h of the optical device compared to a case where the cavity is shaped so that no counterdraft is needed in the cantilever 210. The mold-element 202 is shaped to form a portion 212 of the mold cavity so that the portion of the mold cavity has counterdraft by tapering in the negative z-direction of the coordinate system 299, i.e. in a direction opposite to a direction in which the mold-element 202 is separated from the optical device 201. As the counterdraft is allowed, the shape of the optical device 201 as well as the dividing joints between the mold-elements can be designed more freely than is a case where each mold-element is required to be free from counterdraft.

In the exemplifying case illustrated in FIGS. 2a and 2b, the mold-elements 202 and 203 are adapted to form the mold cavity so that walls of the mold cavity corresponding to the optically active surfaces of the optical device 201 are free from the dividing joints between the mold-elements. Therefore, the optically active surfaces of the optical device 201 are free from traces caused by the dividing joints between the mold-elements.

The optical device 201 and correspondingly the mold cavity can be, for example but necessarily, rotationally symmetric. In this case, the mold elements 202 and 203 are separable from the optical device in directions parallel with the axis 211 of the rotational symmetry. The axis of the rotational symmetry is parallel with the z-axis of the coordinate system 299. For another example, the optical device 201 and correspondingly the mold cavity can be elongated in the direction parallel with the x-axis of the coordinate system 299.

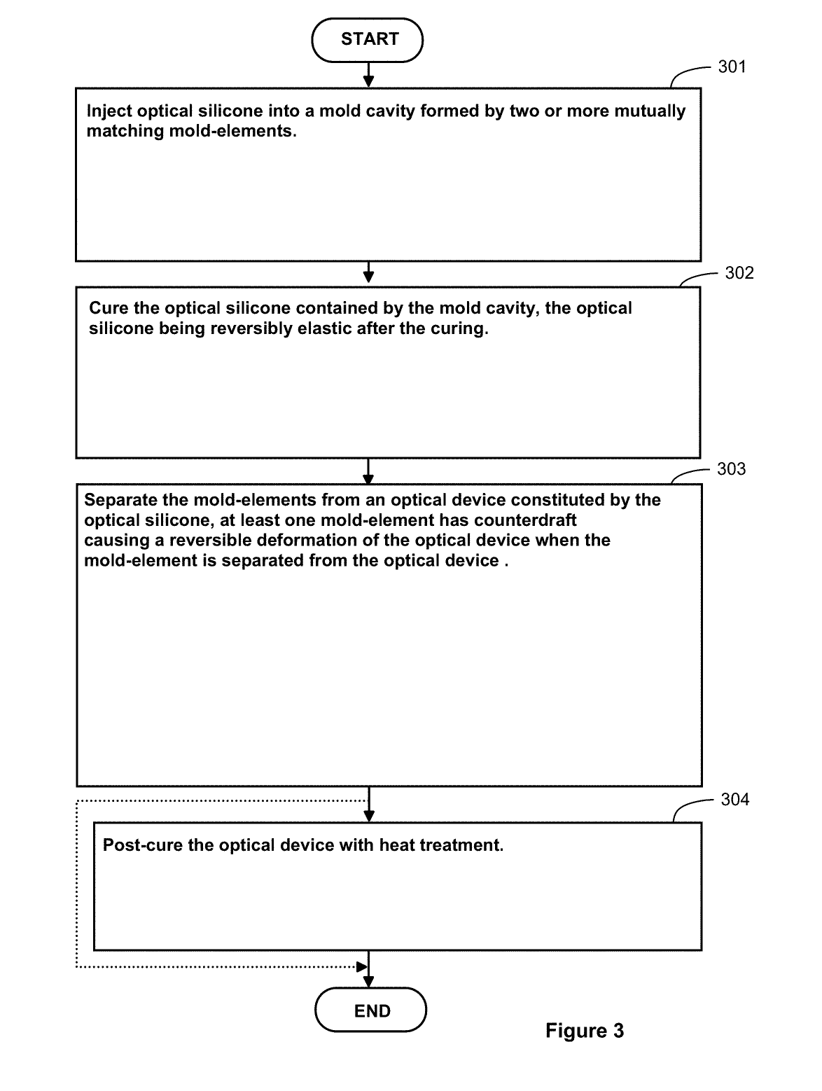

FIG. 3 shows a flowchart of a process according to an exemplifying and non-limiting embodiment of the invention for fabricating an optical device which comprises optically active surfaces for modifying light distribution. The process comprises the following actions:
action 301: injecting optical silicone in fluidic state into a mold cavity formed by two or more mutually matching mold-elements,
action 302: curing the optical silicone contained by the mold cavity, the optical silicone being reversibly elastic after the curing, and
action 303: separating the mold-elements from the optical device constituted by the optical silicone, at least one of the mold-elements having counterdraft causing a reversible deformation in the optical device when the at least one of the mold-elements is separated from the optical device.

The optical silicone can be for example optical grade liquid silicone rubber “LSR”. Commercially available examples of the optical grade LSR are: Momentive® LSR7070 supplied by Momentive Performance Materials Inc., and DOW CORNING® MS-1001, MS-1002, and MS-1003 supplied by Dow Corning Corporation. MS-1001 is the stiffest one and MS-1003 is the softest one from among the optical grade LSRs MS-1001, MS-1002, and MS-1003.

The temperature of the mold cavity can be for example on the range from 115° C. to 170° C. when the optical silicone is injected into the mold cavity, and the injection pressure can be for example on the range from 3 MPa to 13 MPa. The injection can be carried out for example so that the optical silicone is injected to the mold cavity through a channel located at the bottom of the mold cavity and air, and/or other gases, is/are allowed to exit the mold cavity through a vent located at the top of the mold cavity. The pressure is advantageously maintained to prevent the optical silicone from leaking out from the mold cavity when the optical silicone is still in the fluidic state at the beginning phase of the curing.

A process according to an exemplifying and non-limiting embodiment of the invention further comprises post-curing the optical device with heat treatment after the mold-elements have been separated from the optical device. The post-curing is an action 304 in FIG. 3. The post-curing further stiffens the optical device. The post-curing can be carried out in an oven where the temperature can be e.g. on the range from 170° C. to 200° C. depending on the optical silicone material being used. In many cases, the optical silicone is so stiff after the post-curing that the optical device would no longer be able to be separated from the mold-elements after the post-curing. Thus, in these cases, the optical device is separated from the mold-elements prior the optical silicone achieves its final stiffness.

In a process according to an exemplifying and non-limiting embodiment of the invention, the mold-elements form the mold cavity so that walls of the mold cavity corresponding to the optically active surfaces of the optical device are free from dividing joints between the mold-elements.

In a process according to an exemplifying and non-limiting embodiment of the invention, the mold cavity is rotationally symmetric and the mold-elements forming the mold cavity consist of a first mold-element that is separated from the optical device in a first direction parallel with the axis of the rotational symmetry and a second mold-element that is separated from the optical device in a second direction opposite to the first direction.

In a process according to an exemplifying and non-limiting embodiment of the invention, one of the mold-elements comprises a cantilever protruding towards the mold cavity and forming a corresponding cavity on the optical device. At least a part of the cantilever is shaped to have counterdraft causing the reversible deformation in the optical device when the mold-element under consideration is separated from the optical device.

In a process according to an exemplifying and non-limiting embodiment of the invention, one of the mold-elements is shaped to form a portion of the mold cavity so that the portion of the mold cavity has counterdraft by tapering in a direction opposite to a direction in which the mold-element under consideration is separated from the optical device.

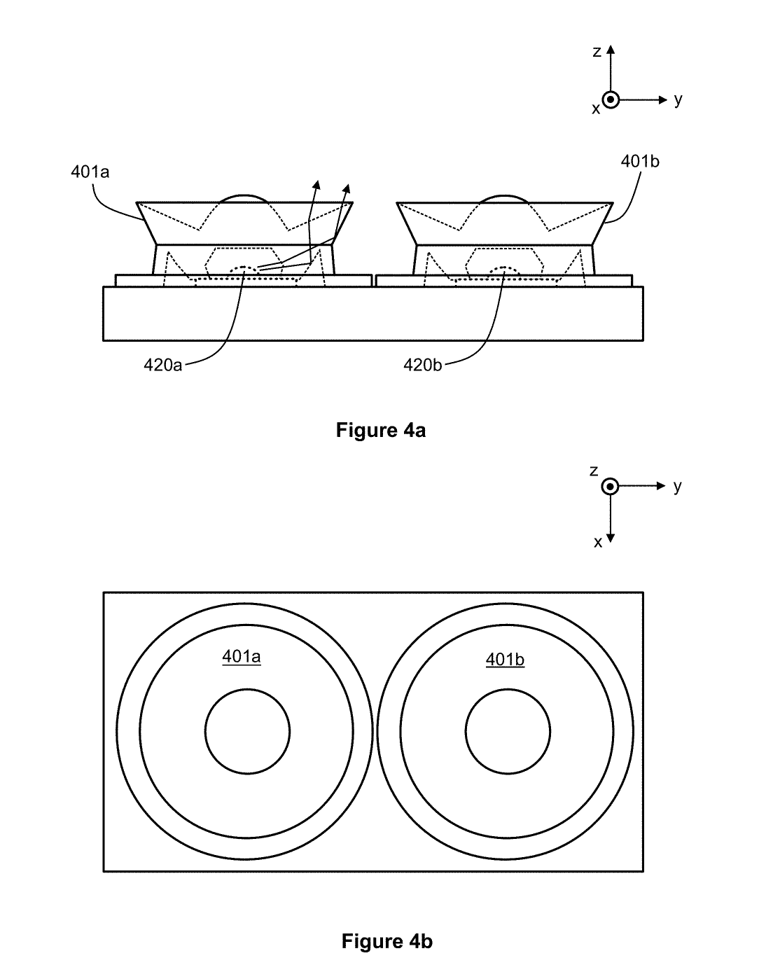

FIG. 4a shows side view of an illuminator system according to an exemplifying and non-limiting embodiment of the invention. FIG. 4b shows a front view of the illuminator system. The illuminator system comprises light sources 420a and 4020b and optical devices 401a and 401b according to an embodiment of the invention for modifying the distribution of the light emitted by the light sources. The light sources are depicted with dashed lines in FIG. 4a. Each of the light sources 402a and 402b can be for example a light emitting diode “LED”, a filament lamp, or a gas-discharge lamp. In FIG. 4a, some of the light beams are depicted with fraction line arrows.

The specific examples provided in the description given above should not be construed as limiting the scope and/or the applicability of the appended claims.

1-14. (canceled)

15. A process for fabricating an optical device comprising optically active surfaces for modifying light distribution, the process comprising:
injecting optical silicone in fluidic state into a mold cavity formed by two or more mutually matching mold-elements,
curing the optical silicone contained by the mold cavity, the optical silicone being reversibly elastic after the curing, and
separating the mold-elements from the optical device constituted by the optical silicone,
wherein at least one of the mold-elements has counterdraft causing a reversible deformation of the optical device when the at least one of the mold-elements is separated from the optical device.

16. A process according to claim 15, wherein the mold-elements form the mold cavity so that walls of the mold cavity corresponding to the optically active surfaces of the optical device are free from dividing joints between the mold-elements.

17. A process according to claim 15, wherein the mold cavity is rotationally symmetric, and the mold-elements forming the mold cavity consist of a first mold-element that is separated from the optical device in a first direction parallel with an axis of rotational symmetry of the mold cavity and a second mold-element that is separated from the optical device in a second direction opposite to the first direction.

18. A process according claim 15, wherein one of the mold-elements comprises a cantilever protruding towards the mold cavity and forming a corresponding cavity on the optical device, at least a part of the cantilever being shaped to have counterdraft causing the reversible deformation of the optical device when the mold-element under consideration is separated from the optical device.

19. A process according to claim 15, wherein one of the mold-elements is shaped to form a portion of the mold cavity so that the portion of the mold cavity has counterdraft by tapering in a direction opposite to a direction in which the mold-element under consideration is separated from the optical device.

20. A process according to claim 15, wherein the process further comprises post-curing (304) the optical device with heat treatment after the mold-elements have been separated from the optical device.

21. A mold for fabricating an optical device comprising optically active surfaces for modifying light distribution, the mold comprising two of more mutually matching mold-elements for forming a mold cavity for receiving material of the optical device, wherein at least one of the mold-elements has counterdraft causing a reversible deformation of the optical device when the at least one of the mold-elements is separated from the optical device.

22. A mold according to claim 21, wherein the mold-elements are adapted to form the mold cavity so that walls of the mold cavity corresponding to the optically active surfaces of the optical device are free from dividing joints between the mold-elements.

23. A mold according to claim 21, wherein the mold cavity is rotationally symmetric, and the mold-elements for forming the mold cavity consist of a first mold-element that is separable from the optical device in a first direction parallel with an axis of rotational symmetry of the mold cavity and a second mold-element that is separable from the optical device in a second direction opposite to the first direction.

24. A mold according to claim 21, wherein one of the mold-elements comprises a cantilever protruding towards the mold cavity and forming a corresponding cavity on the optical device, at least a part of the cantilever being shaped to have counterdraft causing the reversible deformation of the optical device when the mold-element under consideration is separated from the optical device.

25. A mold according to claim 21, wherein one of the mold-elements is shaped to form a portion of the mold cavity so that the portion of the mold cavity has counterdraft by tapering in a direction opposite to a direction in which the mold-element under consideration is separated from the optical device.

26. An optical device obtainable by a process comprising:
injecting optical silicone in fluidic state into a mold cavity formed by two or more mutually matching mold-elements,
curing the optical silicone contained by the mold cavity, the optical silicone being reversibly elastic after the curing, and
separating the mold-elements from the optical device constituted by the optical silicone,
wherein at least one of the mold-elements has counterdraft causing a reversible deformation of the optical device when the at least one of the mold-elements is separated from the optical device.

27. An optical device according to claim 26, wherein optically active surfaces of the optical device are free from traces of dividing joints between the mold-elements.

28. An illuminator system comprising:
at least one optical device for modifying distribution of light, and
at least one light source installed to the at least one optical device and adapted to produce the light
wherein the optical device is obtainable by a process comprising:
injecting optical silicone in fluidic state into a mold cavity formed by two or more mutually matching mold-elements,
curing the optical silicone contained by the mold cavity, the optical silicone being reversibly elastic after the curing, and
separating the mold-elements from the optical device constituted by the optical silicone,
wherein at least one of the mold-elements has counterdraft causing a reversible deformation of the optical device when the at least one of the mold-elements is separated from the optical device.

29. A process according to claim 16, wherein the mold cavity is rotationally symmetric, and the mold-elements forming the mold cavity consist of a first mold-element that is separated from the optical device in a first direction parallel with an axis of rotational symmetry of the mold cavity and a second mold-element that is separated from the optical device in a second direction opposite to the first direction.

30. A process according claim 16, wherein one of the mold-elements comprises a cantilever protruding towards the mold cavity and forming a corresponding cavity on the optical device, at least a part of the cantilever being shaped to have counterdraft causing the reversible deformation of the optical device when the mold-element under consideration is separated from the optical device.

31. A process according to claim 16, wherein one of the mold-elements is shaped to form a portion of the mold cavity so that the portion of the mold cavity has counterdraft by tapering in a direction opposite to a direction in which the mold-element under consideration is separated from the optical device.

32. A mold according to claim 22, wherein the mold cavity is rotationally symmetric, and the mold-elements for forming the mold cavity consist of a first mold-element that is separable from the optical device in a first direction parallel with an axis of rotational symmetry of the mold cavity and a second mold-element that is separable from the optical device in a second direction opposite to the first direction.

33. A mold according to claim 22, wherein one of the mold-elements comprises a cantilever protruding towards the mold cavity and forming a corresponding cavity on the optical device, at least a part of the cantilever being shaped to have counterdraft causing the reversible deformation of the optical device when the mold-element under consideration is separated from the optical device.

34. A mold according to claim 22, wherein one of the mold-elements is shaped to form a portion of the mold cavity so that the portion of the mold cavity has counterdraft by tapering in a direction opposite to a direction in which the mold-element under consideration is separated from the optical device.
